(19) United States
(12) Patent Application Publication
(10) Pub. No.: US 2003/0026611 A1
(43) Pub. Date: Feb. 6, 2003

(54) Camera that takes two simultaneous pictures one of which is a picture of the photographer

(76) Inventor: Frederick Yi-Tung Cho, Mesa, AZ (US)

Correspondence Address: Frederick Yi-Tung Cho, 14441 S. Power Road, Mesa, AZ, 85212, US

(21) Appl. No.: 09/921,436

(22) Filed: Aug. 3, 2001

(51) Int. Cl. G03B 41/00

(52) U.S. Cl. 396/332

(57) ABSTRACT

a camera that enables a photographer to take pictures of himself as he takes pictures of other subjects. The camera has an image-collecting system (lens and CCD) pointed in the forward direction as in an ordinary video camera; it also has an image-collecting system pointed substantially backward towards the photographer. Electronic means in the camera combines the images such that the forward view is the main picture and the backward view (the photographer) appears as a picture-in-picture.

### FEDERAL SPONSORED R&D

None

### RELATED APPLICATIONS

No known related application

### BACKGROUND OF THE INVENTION

The invention relates to photography, more specifically photography for the purpose of remembering special events.

Photography has been a popular way to remember special moments in people's lives;—especially happy moments such as weddings, holidays, vacations, reunions, etc. In most social groups (including families), there is usually one member who takes most of the pictures, so he (or she) ends up being absent from the pictures most of the time. Of course, there are many ways to overcome this problem:—group pictures can be taken with the camera on a tripod while using a self-timer; members of the group can take turns taking pictures; or someone from outside the group (eg., a hired professional photographer) be asked to take the pictures. It is even better to have a camera that enables a photographer to take a picture of himself behind the camera while he is taking a picture of other subjects in front of the camera.

The kind of photography most commonly used to remember special moments are “snap-shots” (still pictures) and “movies” (moving pictures). Snap shots are mostly taken on film or with a digital camera. Several dacades ago, home movies used to be taken with 8 mm or super 8 movie cameras, but film-type home-movie cameras are now mostly replaced by video cameras (camcorders). In any type of photography, the possibility of adding the photographer to the picture gives that picture an extra “personal touch”.

It is the purpose of the present invention to provide a camera with a capability to take composite pictures each having one part showing the main subject in front of the camera while the photographer is shown in a smaller picture inside the main picture (picture-in-picture).

### SUMMARY OF THE INVENTION

One preferred embodiment of the invention provides a video camera that enables a photographer to take pictures of himself as he takes pictures of other subjects. The camera has an image-collecting system (lens and CCD) pointed in the forward direction as in an ordinary video camera; it also has an image-collecting system pointed substantially backward towards the photographer. Electronic means in the camera combines the images such that the forward view is the main picture and the backward view (the photographer) appears in a picture-in-picture.

### BRIEF DESCRIPTION OF THE DRAWINGS

FIG. 1 shows a perspective view of a camera which is a preferred embodiment of the present invention.

FIG. 2 shows a flow chart of the image collecting, processing, and storage means in a camera according to the present invention.

### DETAILED DESCRIPTION OF THE INVENTION

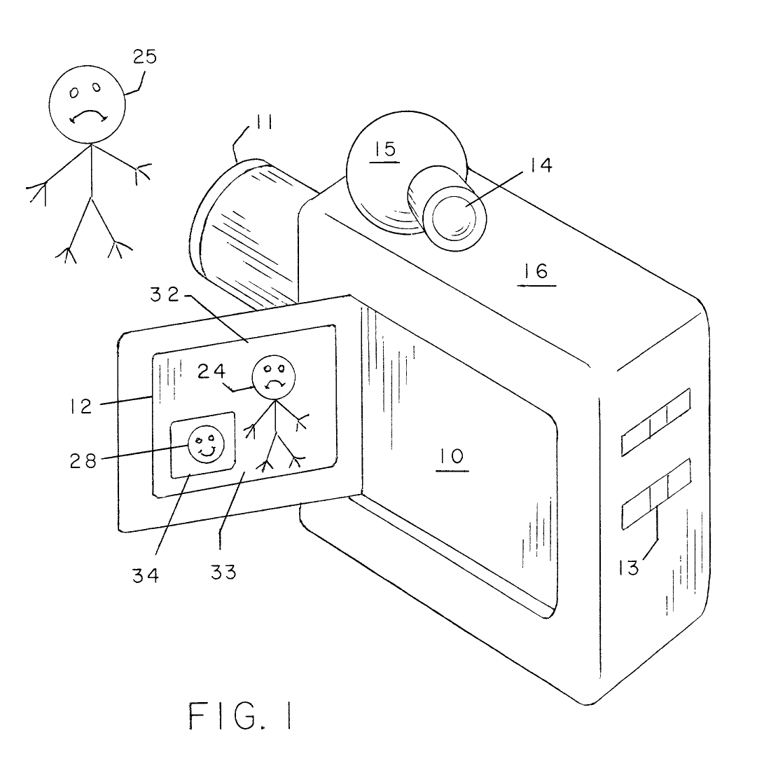

A camera 10 according to the present invention is shown in FIG. 1. Like an ordinary video camera, camera 10 has a lens 11, a view-finder 12, and miscellaneous control buttons 13. Unlike ordinary video cameras, camera 10 also has a second lens 14 mounted on an extension housing 15. The extension housing 15 is attached to the main housing 16 by means of a swivel (not shown in FIG. 1) that enables some adjustment of the angle between the two lenses 11 and 14.

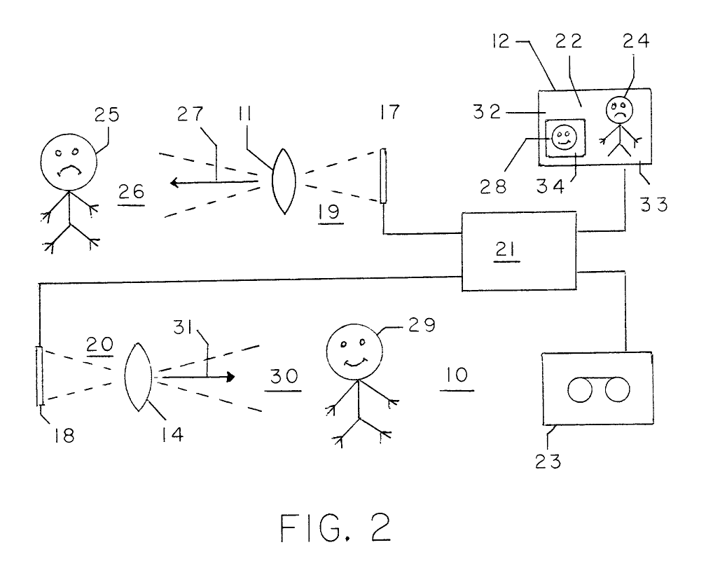

FIG. 2 shows a flow-chart to illustrate the functions of various parts of the camera 10. Lenses 11 and 14 are used to generate images that are picked up by charge coupled devices (CCD's) 17 and 18. Together, lens 11 and CCD 17 form an image-collecting system 19; similarly, lens 14 and CCD 18 form an image-collecting system 20. Outputs of the CCD's are of course electrical (video) signals (electronic images). These signals are fed to an image-processing system 21, which serves as means for combining the images into one combined picture 22. The output of the image-processing system 21 is also fed to a magnetic tape recorder 23 which serves as means for saving the picture 22. The output of the image-processing system 21 is also fed to the viewfinder 12.

FIGS. 1 and 2 show the image-collecting system 19 collecting images 24 from an object 25 in an area 26 centered around a direction 27 in front of the camera 10. Similarly, the image-collecting system 20 collects images 28 from an object 29 in an area 30 centered around a direction 31 behind the camera 10 (towards the photographer).

The images that have been collected by systems 19 and 20 are processed in system 21 to give a combined picture 32 shown in view finder 12. Most areas of the combined picture 32 are occupied by the main picture 33 which is a picture of the images collected by system 19. A smaller area is allowed for the images collected by system 20, and these images appear as a picture-in-picture 34.

Optionally the picture-in-picture feature can be turned off by pushing one of the buttons 13; also optionally, the picture-in-picture feature is turned on and off automatically by a times switch so that the photographer is shown in the picture for a predetermined period of time and then turned off. When the picture-in-picture is turned off, then only images from collection system 19 is shown.

Manufacture of a camera such as the one shown in FIGS. 1 and 2 requires no new technology. Most of the parts are standard parts in ordinary camcorders. An inexpensive surveillance camera might be used as the second image-collecting system 20. Electronic circuits (IC's) for generating picture-in-picture are available for home-entertainment televisions.

A magnetic tape recorder 23 is shown in FIG. 2 as the means for saving the picture. Magnetic tapes are indeed the most commonly used means for data-storage in camcorders, however, there are also camcorders using other means (such as optical discs) for data storage. Therefore the means for saving pictures is not limited to Magnetic tapes.

FIGS. 1 and 2 show the image-collecting system 19 collecting images 24 from an object 25 in an area 26 centered around a direction 27 in front of the camera 10. Similarly, the image-collecting system 20 collects images 28 from an object 29 in an area 30 centered around a direction 31 behind the camera 10 (towards the photographer).

The images that have been collected by systems 19 and 20 are processed in system 21 to give a combined picture 32 shown in view finder 12. Most areas of the combined picture 32 are occupied by the main picture 33 which is a picture of the images collected by system 19. A smaller area is allowed for the images collected by system 20, and these images appear as a picture-in-picture 34.

Optionally the picture-in-picture feature can be turned off by pushing one of the buttons 13; also optionally, the picture-in-picture feature is turned on and off automatically by a timed switch so the photographer is shown in the picture for a predetermined period of time and then turned off. When the picture-in-picture is turned off, then only images from collection system 19 is shown.

Manufacture of a camera such as the one shown in FIGS. 1 and 2 requires no new technology. Most of the parts are standard parts in ordinary camcorders. An inexpensive surveillance camera might be used as the second image-collecting system 20. Electronic circuits (IC's) for generating picture-in-picture are available for home-entertainment televisions.

A magnetic tape recorder 23 is shown in FIG. 2 as the means for saving the picture. Magnetic tapes are indeed the most commonly used means for data-storage in camcorders, however, there are also camcorders using other means (such as optical discs) for data storage. Therefore the means for saving pictures is not limited to Magnetic tapes.

CCD's 17 and 18 were shown in FIG. 2 for converting the optical images to electrical signals. Other devices could have been used instead of CCD's for such conversion—it is well known that several decades ago, CCD's were seldom used in video cameras, in those days, video cameras had vidicons. Video cameras of the future may have use other devices instead of CCD's and vidicons.

Another application for the present invention is for digital still-cameras. A digital still-camera embodiment of the invention will probably be different from camera 10 (shown in FIG. 1) in exterior appearance, but it will have similar image-collecting systems and similar integrated circuits for generating picture-in-picture. Digital still-cameras typically use digital electronic memory devices for data storage.

There are many variations of applications for the invention, for example, a camera can be made to function in a mode in which the main picture is moving (video) but the picture-in-picture is frozen (still) and/or appear only for short moments of time. Cameras can be made with mirror(s) or prism(s) in the image-collecting systems so the lens(es) and CCD ('s) do not necessarily point directly at the respective subjects. Such variations are useful in some situations and would no doubt be easily devised by anyone skilled in the art.

Cameras can be made with the second image-collecting system 20 so compact that the whole thing (including lens 14 and CCD 18) can be imbedded into the main housing 16, with the lens 14 peeping out a window, thus not needing to have an extension housing 15 at all.

Specific preferred embodiments have been described here to illustrate the features of the invention, they should not be construed to limit the invention. Scope of the invention is defined by the claims below.

I claim:

1 A camera comprising:
at least two separate image-collecting systems for collecting images of objects from at least two separate areas that are centered at substantially different directions;
means for saving said picture thereby enabling a photographer to take pictures of himself as he takes pictures of other subjects.

2 A camera according to claim 1 wherein said separate areas are centered at substantially opposite directions.

3 A camera according to claim 1 wherein said image-collecting systems each comprise a lens and a CCD.

4 A camera according to claim 1 further comprising means for combining the images from said two separate areas into one combined picture with the images from one area as the main picture occupying most of the area in the combined picture and the images from the other area as a smaller picture-in-picture.

5 A camera according to claim 4 wherein said means for combining the two collected images into one combined picture comprises one of the electronic circuits for generating picture-in-pictures for use in home entertainment televisions.

6 A camera according to claim 1 wherein said means for saving said picture is one of the devices in a group used for data storage in video-cameras, said group of devices includes magnetic tapes and optical discs.

7 A camera according to claim 1 wherein said means for saving said picture is an electronic digital memory device.
